(19) United States
(12) Patent Application Publication
(10) Pub. No.: US 2025/0089063 A1
(43) Pub. Date: Mar. 13, 2025

(54) UPDATING TRANSMISSION CONFIGURATION INDICATOR STATES FOR PERIODIC COMMUNICATIONS

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US)

(21) Appl. No.: 18/727,507

(22) PCT Filed: Mar. 9, 2022
(86) PCT No.: PCT/CN2022/079883

§ 371 Date: Jul. 9, 2024

(51) Int. Cl. H04W 72/231; H04W 16/28; H04W 76/20

(52) U.S. Cl. CPC H04W 72/231; H04W 16/28; H04W 76/20

(57) ABSTRACT

Methods, systems, and devices for wireless communications are described. The method may include a user equipment (UE) receiving a first control information message indicating a first transmission configuration indicator (TCI) codepoint mapped to one or more first TCI states. Additionally, the first control information message may activate a set of periodic occasions for communications with a first transmission and reception point (TRP), a second TRP, or both. After some time, the UE may receive a second control information message indicating a second TCI codepoint mapped to a single second unified TCI state and select a unified TCI state from the one or more first unified TCI states or the single second unified TCI state to apply to at least a portion of the communications.

### CROSS REFERENCE

The present Application is a 371 national phase filing of International PCT Application No. PCT/CN2022/079883 by YUAN et al., entitled “UPDATING TRANSMISSION CONFIGURATION INDICATOR STATES FOR PERIODIC COMMUNICATIONS,” filed Mar. 9, 2022, which is assigned to the assignee hereof, and which is expressly incorporated by reference in its entirety herein.

### FIELD OF TECHNOLOGY

The following relates to wireless communications, including updating transmission configuration indicator (TCI) states for periodic communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a UE may communicate with one or more transmission and reception points (TRPs) of a network entity (e.g., a base station). In some examples, the UE may receive control signaling from the network entity indicating one or more transmission configuration indicator (TCI) states to be used by the UE. Additionally, the same or different control signaling may also activate semi-persistent P/SP) communications between the UE and the network entity. Upon P/SP activation, the UE may transmit signaling to the network entity. Nevertheless, the TCI states to be used for the P/SP signaling in connection with different TRPs may not be clear without additional rules or procedures.

### SUMMARY

The described techniques relate to improved methods, systems, devices, and apparatuses that support updating transmission configuration indicator (TCI) states for periodic communications. For example, the described techniques provide for a user equipment (UE) to determine a TCI state to use for periodic or semi-persistent (P/SP) communication with one or more transmission and reception points (TRPs). In some examples, the UE may receive first control information indicating a TCI codepoint mapped to one or more unified TCI states. Additionally, the first control information may activate a set of periodic occasions for communication with one or more TRPs using the one or more unified TCI states. At a later time and prior to deactivation of the set of periodic occasions, the UE may receive second control information indicating a single unified TCI state. In one example, upon receiving the second control information, the UE may apply the single unified TCI state to the periodic occasions that may occur after receiving the second control information. Alternatively, the UE may deactivate the periodic occasions that may occur after receiving the second control information. Using the methods as described herein may allow the UE to determine a TCI state in the case where control information that indicates a TCI state interrupts ongoing periodic communications.

(This summary will be completed upon final approval of the claims)

### BRIEF DESCRIPTION OF THE DRAWINGS

FIGS. 1 and 2 illustrate examples of a wireless communications system that supports updating transmission configuration indicator (TCI) states for periodic communications in accordance with one or more aspects of the present disclosure.

FIG. 3 illustrates an example of a TCI state update scheme that supports updating TCI states for periodic communications in accordance with one or more aspects of the present disclosure.

FIGS. 4A and 4B illustrate examples of a TCI state update scheme that supports updating TCI states for periodic communications in accordance with one or more aspects of the present disclosure.

FIGS. 5A, 5B, and 5C illustrate examples of a TCI state update scheme that supports updating TCI states for periodic communications in accordance with one or more aspects of the present disclosure.

FIGS. 6A and 6B illustrate examples of a TCI state update scheme that supports updating TCI states for periodic communications in accordance with one or more aspects of the present disclosure.

FIG. 7 illustrates an example of a process flow that supports updating TCI states for periodic communications in accordance with one or more aspects of the present disclosure.

FIGS. 8 and 9 show block diagrams of devices that support updating TCI states for periodic communications in accordance with one or more aspects of the present disclosure.

FIG. 10 shows a block diagram of a communications manager that supports updating TCI states for periodic communications in accordance with one or more aspects of the present disclosure.

FIG. 11 shows a diagram of a system including a device that supports updating TCI states for periodic communications in accordance with one or more aspects of the present disclosure.

FIGS. 12 through 15 show flowcharts illustrating methods that support updating TCI states for periodic communications in accordance with one or more aspects of the present disclosure.

### DETAILED DESCRIPTION

A user equipment (UE) may communicate with one or more transmission and reception points (TRPs) of a network entity (e.g., a base station). Additionally, the UE may be configured to utilize periodic or semi-persistent (P/SP) communications and may receive control signaling from the network entity via one or both of the one or more TRPs, thus activating the P/SP communications. Once activated, the UE may transmit or receive signaling from the one or more TRPs during the configured P/SP occasions. In some examples, the control signaling (e.g., radio resource control (RRC) signaling, a medium access control-control element (MAC-CE), or downlink control information (DCI)) activating the P/SP communications may also include an indication of a transmission configuration indicator (TCI) codepoint that is mapped to one or more unified TCI states, where each unified TCI state may correspond to a respective TRP of the one or more TRPs. For example, the UE may receive DCI from a first TRP activating a P/SP communications and indicating a TCI codepoint mapped to a unified TCI state for which to apply to the P/SP transmissions to or from the first TRP. However, at some later time, the UE may receive second control signaling (e.g., second DCI) indicating a TCI codepoint mapped to a single unified TCI state. In this example, the UE may not know which unified TCI state (e.g., either the unified TCI state indicated in the control signaling or the unified TCI state indicated in the second control signaling) to apply to future P/SP occasions.

In some examples, the UE may receive control signaling (e.g., RRC signaling, a MAC-CE or DCI) that activates P/SP communications and indicates a TCI codepoint mapped to a first unified TCI state associated with a TRP and at a later time, receive second control signaling (e.g., second DCI) indicating a TCI codepoint mapped to a second unified TCI state. In such cases, the UE may select the second unified TCI state to apply to future P/SP communications (e.g., transmission over periodic or P/SP occasions that occur after the second control signaling), without regard to which TRP was previously associated with the first unified TCI state. In another example, the UE may receive the control signaling (e.g., DCI) activating P/SP communications and indicating the TCI codepoint mapped to at least a first unified TCI state and a second unified TCI state and at a later time, receive second control signaling (e.g., second DCI) indicating a TCI codepoint mapped to a third unified TCI state. In such an example, the UE may select the third TCI state to apply to future P/SP communications (e.g., P/SP communications to and from all the corresponding TRPs). Alternatively, the UE may deactivate P/SP communications based on receiving the second control signaling. That is, the UE may not transmit or receive over P/SP communications occasions that occur after receiving the second control signaling. The P/SP occasions for different TRPs may be spatial domain multiplexed, single frequency networked, time domain multiplexed, frequency domain multiplexed, etc.

Aspects of the disclosure are initially described in the context of wireless communications systems. Additional aspects are described in the context of TCI state update schemes and a process flow. Aspects of the disclosure are further illustrated by and described with reference to apparatus diagrams, system diagrams, and flowcharts that relate to updating TCI states for periodic communications.

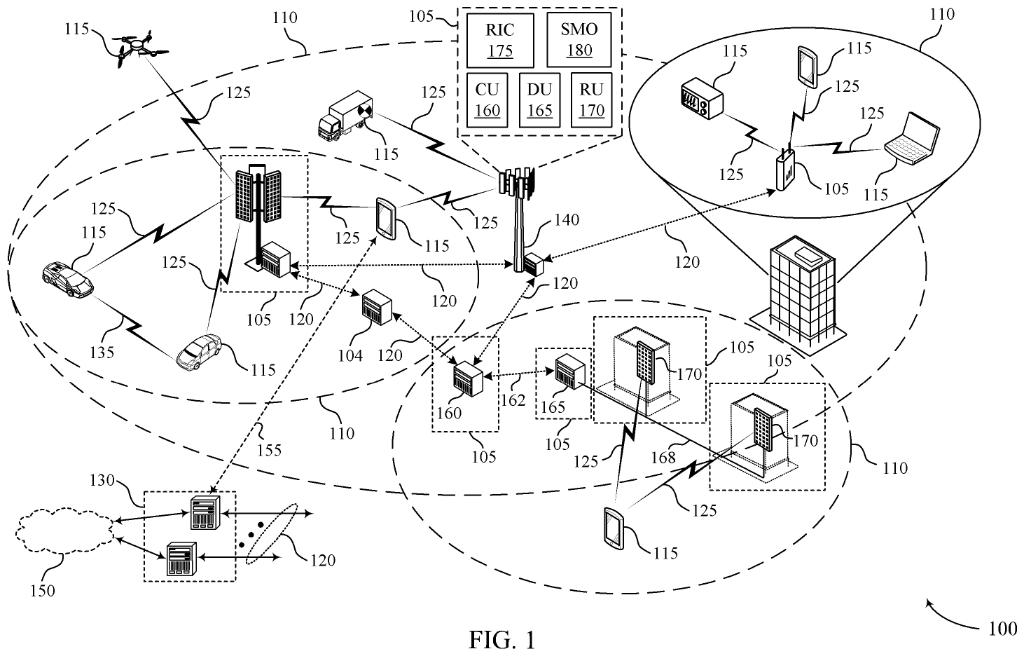

FIG. 1 illustrates an example of a wireless communications system 100 that supports updating TCI states for periodic communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support updating TCI states for periodic communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Ns may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

As described herein, a UE 115 may determine a TCI state to use for periodic communication with one or more TRPs of the network entity 105. In some examples, the UE 115 may receive a first DCI indicating a TCI codepoint mapped to one or more unified TCI states. Additionally, the first DCI may activate a set of periodic occasions for communication with one or more TRPs using the one or more unified TCI states. At a later time and prior to deactivation of the set of periodic occasions, the UE 115 may receive a second DCI indicating a single unified TCI state. In one example, upon receiving the second DCI, the UE 115 may apply the single unified TCI state to the periodic occasions that may occur after receiving the second DCI. Alternatively, the UE 115 may deactivate the periodic occasions that may occur after receiving the second DCI. Using the methods as described herein may allow the UE 115 to determine a unified TCI state in the case that a DCI that indicates a TCI state interrupts ongoing periodic communications.

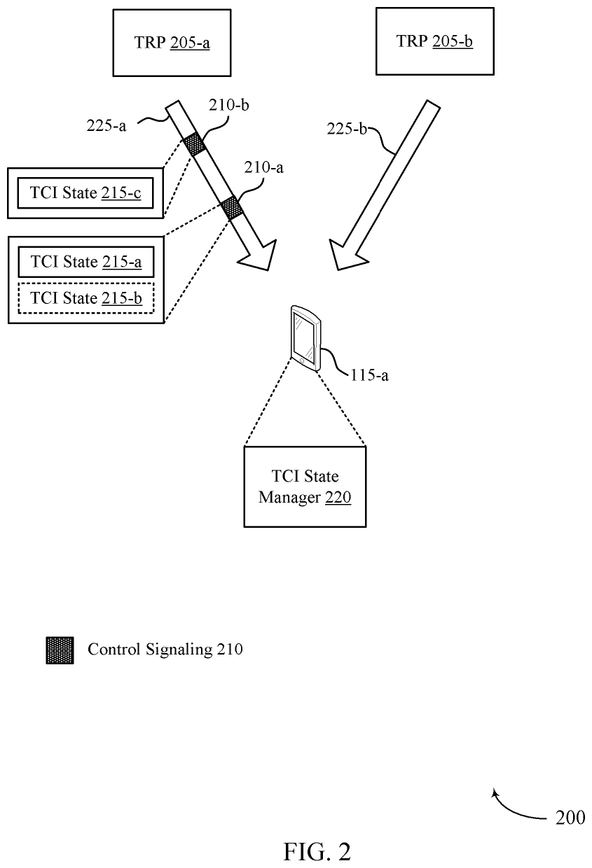

FIG. 2 illustrates an example of a wireless communications system 200 that supports updating TCI states for periodic communications in accordance with one or more aspects of the present disclosure. In some examples, the wireless communications system 200 may implement aspects of a wireless communications system 100. For example, the wireless communications system 200 may include a UE 115-a which may be an example of a UE 115 as described with reference to FIG. 1.

In some examples, a UE 115-a and a network may connect through one or more TRPs 205. For example, the UE 115-a may communicate with one or both of a TRP 205-a and a TRP 205-b via a communication link 225 (e.g., a communication link 225-a and a communication link 225-b). In the case that the UE 115-a is communicating with multiple TRPs 205, the UE 115-a and the multiple TRPs 205 may communicate with one another using spatial domain duplexing (SDM), FDM, TDM, or an SFN.

Using SDM, the UE 115-a may receive a first downlink signal from the TRP 205-a and a second downlink signal from the TRP 205-b using a same set of frequency and time resources. However, the first downlink signal and the second downlink signal may be mapped to different spatial layers. Using FDM, the UE 115-a may receive the first downlink signals from the TRP 205-a using a first set of resources and the second downlink signal from the TRP 205-b using a second set of resources, where the first set of resource and the second set of resources do not overlap in frequency. Using TDM, the UE 115-a may receive the first downlink signals from the TRP 205-a using a first set of resources and the second downlink signal from the TRP 205-b using a second set of resources, where the first set of resource and the second set of resources do not overlap in time. Using SFN, the UE 115-a may receive the first downlink signal from the TRP 205-a and the second downlink signal from the TRP 205-b using a same set of frequency and time resources. However, the first downlink signal and the second downlink signal may be received using different directional beams. In some examples, the UE 115-a may apply SDM, FDM, TDM, and SFN to uplink communications. That is, the UE 115-a may transmit a first uplink signal to the TRP 205-a and a second uplink signal to the TRP 205-b using SDM, FDM, TDM, or SFN. The first downlink signal and the second downlink signal may be transmitted over resources of a PDCCH (physical downlink control channel), a PDSCH (physical downlink shared channel), or may be an example of a CSI-RS. The first uplink signal and the second uplink signal may be transmitted over resources of a PUSCH (physical uplink shared channel), a PUCCH (physical uplink control channel), or may be an example of a sounding reference signal (SRS).

Additionally, each TRP 205 may communicate with the UE 115-a using a directional beam. For example, the TRP 205-a may transmit the first downlink signal to the UE 115-a using a first directional beam and the TRP 205-b may transmit the second downlink signal to the UE 115-a using a second directional beam. In some examples, the UE 115-a may determine the directional beam to use to receive downlink signals from each TRP 205 based on an indicated TCI state. The indicated TCI state may include a source reference signal and an intended quasi co-location type that may be applied. In some examples, the TCI state may be referred to as a unified TCI state within a unified TCI framework. A unified TCI framework allows for a TCI state to be applied for multiple channels. There may be different types of unified TCI states. For example, the different types of unified TCI states may be a joint downlink/uplink common TCI state, a separate downlink common TCI state, a separate uplink common TCI state, a separate downlink single channel TCI state, a separate uplink single channel TCI state, and an uplink spatial relation information (SRI). The joint downlink/uplink common TCI state may indicate a common beam for at least one downlink channel and at least one uplink channel. The separate downlink common TCI state and the separate uplink common TCI state may indicate a common beam for more than one downlink or uplink channel respectively. The separate downlink single channel TCI state and the separate uplink single channel TCI state may include a beam for a single uplink or downlink channel respectively. Lastly, the SRI may indicate a beam through indicating an SRS resource for a single uplink channel where the beam previously applied to the SRS resource may be applied for the uplink channel.

In some examples, the UE 115-a may receive the indication of the unified TCI state via control signaling 210 (e.g., DCI, a medium access control control element (MAC-CE), or RRC signaling) from the TRPs 205. For example, the UE 115-a may receive DCI from the TRP 205-a scheduling signaling over a downlink shared channel, where the DCI may select a unified TCI state to be used for reception of the signaling over the downlink shared channel. In some examples, the DCI may select a TCI codepoint and the TCI codepoint may be mapped to one or more unified TCI states.

In some examples, each TRP 205 may transmit DCI to the UE 115-a indicating a respective TCI state (e.g., multiple DCI (mDCI)). In such an example, the UE 115-a may receive the mDCI over different CORESETs and apply the TCI codepoint indicated in the mDCI to the CORESET (e.g., CORESETPoolIndex) over which the mDCI was received. The TCI codepoint, in such an example, may be mapped to one TCI state (e.g., for single TRP operation). In another example, a single TRP 205 may transmit DCI indicating TCI states for multiple TRPs 205 (e.g., single DCI (sDCI)). In such an example, the UE 115-a may receive sDCI over a CORESET and the sDCI may indicate a TCI codepoint mapped to multiple unified TCI states, where each TCI state of the multiple unified TCI states is mapped to a corresponding TRP 205. For example, in the example of FIG. 2, the UE 115-a may receive, from TRP 205-a, DCI indicating a TCI codepoint mapped to a TCI state 215-a corresponding to the TRP 205-a and a TCI state 215-b corresponding to the TRP 205-b. When receiving signals from the TRP 205-a scheduled by the sDCI, the UE 115-a may use a directional beam based on TCI state 215-a and when receiving signals from the TRP 205-b scheduled by the sDCI, the UE 115-a may use a directional beam based on TCI state 215-b.

In some examples, the UE 115-a may be configured to use periodic or P/SP communications. Unlike dynamic scheduling, in order to use P/SP communications, the UE 115-a may receive control signaling (e.g., RRC signaling, a MAC-CE, or DCI) activating P/SP communications. The UE 115-a may be configured to use multiple different P/SP communications. For example, the UE 115-a may be configured by RRC signaling for periodical PDCCH receptions in CORESETs and associated search space sets, for periodical CSI-RS receptions, for P/SP PUSCH transmission of configured grant type-1, for periodical SRS transmissions, or for periodical CSI-RS reports on PUCCHs. In another example, the P/SP communications may be activated by DCI or MAC-CE signaling for P/SP PDSCH receptions, for P/SP CSI-RS receptions, for P/SP PUSCH transmissions of configured grant type-2, for P/SP CSI-RS receptions, for P/SP SRS transmissions, or for P/SP CSI-RS reports on PUCCH or PUSCH transmissions. For example, the UE 115-a may receive a DCI activating P/SP PDSCH receptions using semi-persistent scheduling (SPS).

Once P/SP communications is activated, the UE 115-a may receive or transmit signaling to one or more unified TRPs 205 using resources periodically over a set of P/SP occasions until the UE 115-a receives control signaling deactivating the P/SP communications. In some examples, as described above, the control signaling activating P/SP may also include an indication of a TCI codepoint mapped to one TCI state (e.g., single TRP operation) or more than one TCI state (e.g., multi-TRP operation). For example, the UE 115-a may receive first control signaling indicating a TCI codepoint mapped TCI state 215-a corresponding to TRP 205-a. However, after receiving the first control signaling and prior to deactivation of P/SP communication, the UE 115-a may receive second control signaling indicating a TCI codepoint mapped to a different TCI state 215 different from the TCI state 215 indicated in the first control signaling. For example, the UE 115-a may receive the second control signaling indicating a TCI codepoint mapped to a TCI state 215-c. In such situation, the UE 115-a may not have knowledge on which TCI state (e.g., the TCI state 215-a or the TCI state 215-c) to apply to the remainder of the P/SP occasions if the second DCI is received prior to deactivation of P/SP. The periodic communications may be referred to as P/SP communications, and the periodic occasions may be referred to as P/SP occasions.

As described herein, the UE 115-a may implement TCI state manager 220 to update a TCI state 215 for P/SP communications. In one example, the UE 115-a may communicate with a single TRP 205-a and receive control signaling 210-a (e.g., sDCI) indicating a TCI codepoint mapped to a TCI state 215-a corresponding to the TRP 205-a. Additionally, the control signaling 210-a may activate P/SP communications over a set of P/SP occasions. As such, the UE 115-a may utilize the TCI state 215-a to receive P/SP communications over at least a first subset of the set of P/SP occasions. In some examples, after receiving the control signaling 210-a and prior to deactivating P/SP communications, the UE 115-a may receive control signaling 210-b (e.g., a DCI or a MAC-CE) indicating a TCI codepoint mapped to a TCI state 215-c corresponding to the TRP 205-a. Upon receiving the control signaling 210-b, using the TCI state manager 220, the UE 115-a may update the TCI state 215-a to be the TCI state 215-c. That is, the UE 115-a may apply the TCI state 215-c to a second subset of P/SP occasions of the set of P/SP occasions that occurs after the first subset of P/SP occasions or P/SP occasions that occur after the control signaling 210-b is received.

In another example, the UE 115-a may communicate with multiple TRPs 205. For example, the UE 115-a may communicate with a TRP 205-a and TRP 205-b and receive control signaling 210-a (e.g., sDCI) indicating a TCI codepoint mapped to a TCI state 215-a corresponding to the TRP 205-a and a TCI state 215-b corresponding to a TRP 205-b. Additionally, the control signaling 210-a may activate P/SP communications over a set of P/SP occasions for each of the TRP 205-a and the TRP 205-b. As such, the UE 115-a may utilize the TCI state 215-a to receive P/SP communications from the TRP 205-a and the TCI state 215-b to receive P/SP communications over at least a first subset of the set of P/SP occasions. In some examples, after receiving the control signaling 210-a and prior to deactivating P/SP communications, the UE 115-a may receive control signaling 210-b (e.g., a DCI or a MAC-CE) indicating a TCI codepoint mapped to a TCI state 215-c. Upon receiving the control signaling 210-b, using the TCI state manager 220, the UE 115-a may update the TCI state 215-a and the TCI state 215-b to be the TCI state 215-c. That is, the UE 115-a may apply the TCI state 215-c to a second subset of P/SP occasions of the set of P/SP occasions that occurs after the first subset of P/SP occasions or P/SP occasions that occurs after the control signaling 210-b is received. Alternatively, the control signaling 210-b indicating the TCI state 215-c may serve as an indication to deactivate. As such, upon receiving the control signaling 210-b, the UE 115-b may deactivate P/SP communications and not receive P/SP signaling over the second subset of P/SP occasions.

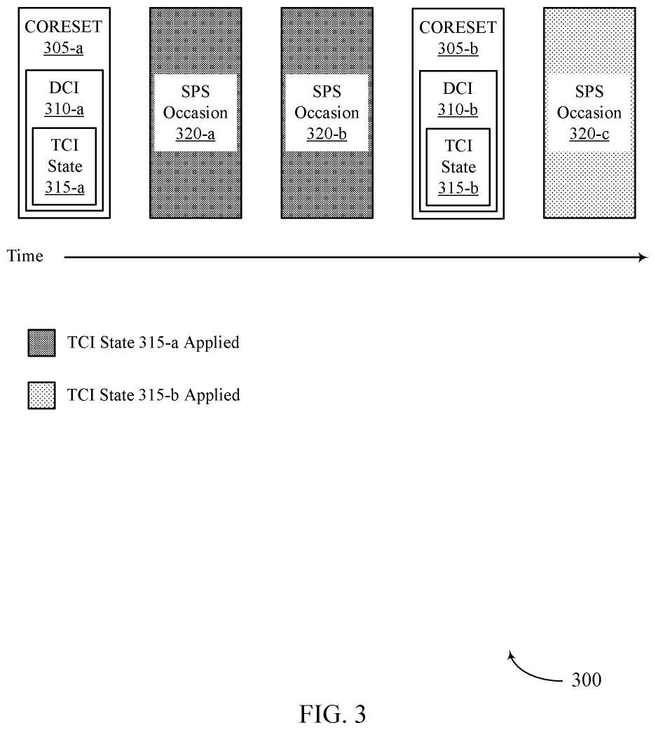

FIG. 3 illustrates an example of a TCI state update scheme 300 that supports updating TCI states for periodic communications in accordance with one or more aspects of the present disclosure. In some examples, the TCI state update scheme 300 may be implemented by aspects of a wireless communications system 100 and a wireless communications system 200. For example, the TCI state update scheme 300 may be implemented by a TRP 205 or a UE 115 as described with reference to FIG. 2.

As described in FIG. 2, a UE may communicate with a single TRP (e.g., single TRP operation). In such an example, the UE may receive DCI 310-a over resources of a CORESET 305-a. The DCI 310-a may include a TCI codepoint mapped to a TCI state 315-a corresponding to the TRP (e.g., TRP ID of the TRP) and additionally, the DCI 310-a may activate SPS (e.g., one type of P/SP communications). That is, upon receiving the DCI 310-a, the UE may receive signaling over resources repeated over a set of SPS occasions 320.

In the example of FIG. 3, the UE may receive signaling from the TRP over resources of an SPS occasion 320-a, an SPS occasion 320-b, and an SPS occasion 320-c. The SPS occasion 320-a may occur before the SPS occasion 320-b and the SPS occasions 320-b may occur before the SPS occasions 320-c. In some examples, the UE may receive DCI 310-b over resources of a CORESET 305-a after SPS occasion 320-b and prior to SPS occasion 320-c. DCI 310-b may include a TCI codepoint mapped to the TCI state 315-b (e.g., different from the TCI state 315-b). In such an example, the UE may apply the TCI state 315-a to the SPS occasion 320-a and the SPS occasion 320-b and apply the TCI state 315-b to the SPS occasion 320-c. That is, if a CORESET is configured to use the TCI state 315-a (e.g., the CORESET 305-a) and the TCI state 315-b is selected at a later time, the TCI state 315-c will be applied to the CORESET regardless of the configured TRP.

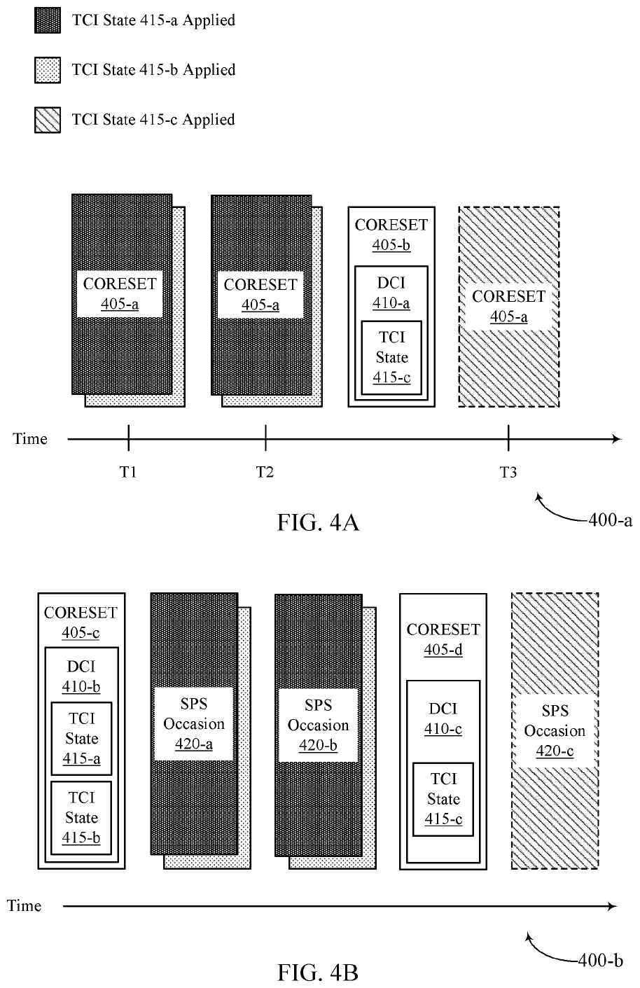

FIGS. 4A and 4B illustrate examples of a TCI state update scheme 400 (e.g., a TCI state update scheme 400-a and a TCI state update scheme 400-b) that supports updating TCI states for periodic communications in accordance with one or more aspects of the present disclosure. In some examples, the TCI state update scheme 400-a and the TCI state update scheme 400-b may be implemented by aspects of a wireless communications system 100 and a wireless communication system 200. For example, the TCI state update scheme 400-a and the TCI state update scheme 400-b may be implemented by a TRP 205 or a UE 115 as described with reference to FIG. 2.

As described in FIG. 2, a UE may communicate with multiple TRPs (e.g., multi-TRP operation). For example, the UE may communicate with a first TRP and a second TRP. In some examples, in order to receive signaling from both the first TRP and the second TRP, the UE may operate in accordance to SFN. Using SFN, the UE may receive signaling from the first TRP and the second TRP using the same frequency and time resources, but utilizing different directional beams.

In the example of FIG. 4A, the UE may be configured with a CORESET 405-a and utilize the CORESET 405-a to receive control signaling. In some examples, the UE may be configured with the CORESET 405-a to receive PDCCHs periodically in the associated search space sets, which is one type of P/SP communications. For example, as shown in FIG. 4A, the CORESET 405-a may be received periodically at T1, T2, and T3. In some examples, the CORESET 405-a may be originally configured as an SFN CORESET (e.g., SFN CORESET reception at T1). That is, the UE may receive control signaling from the first TRP and the second TRP over resources of the CORESET 405-a. Additionally, the CORESET 405-a may be originally configured to utilize a TCI state 425-a mapped to first TRP and a TCI state 425-b mapped to the second TRP.

However, in some examples, the UE may receive DCI 410-a over resources of a CORESET 405-b during repetition of the CORESET 405-a (e.g., after the CORESET 405-a repetition at T2), where the DCI 410-a indicates a TCI codepoint mapped to single TCI state 415-c. In some examples, in response to receiving the DCI 410-a, the CORESET 405-a (e.g., reception at T3) may become a single TCI state CORESET with the TCI state 415-c applied. That is, the UE may receive control signaling using a directional beam based on the TCI state 415-c over resources of the CORESET 405-a starting at T3. In another example, in response to receiving the DCI 410-a, the UE may deactivate search spaces associated with the CORESET 405-a starting at T3. That is, the DCI 410-a may serve as a deactivation DCI.

In the example of FIG. 4B, the UE may receive DCI 410-b over resources of a CORESET 405-c. The DCI 410-b may include a TCI codepoint mapped to the TCI state 415-a corresponding to the first TRP and the TCI state 415-b corresponding to the second TRP. Additionally, the DCI 410-b may activate P/SP communications. For example, the DCI 410-b may activate SPS. That is, upon receiving the DCI 410-b, the UE may receive signaling over resources periodically or semi-persistently over a set of SPS occasions 420. As described above, the UE may operate in accordance to SFN between two TRPs for the SPS. As such, the SPS occasions 420 for the first TRP may overlap time and frequency resources of the SPS occasion 420 for the second TRP.

The UE may receive signaling from the first TRP using a directional beam based on the TCI state 415-a and the second TRP using a directional beam based on the TCI state 415-b over resources of an SPS occasion 420-a and an SPS occasion 420-b. After the SPS occasion 420-b, the UE may receive DCI 410-c including a TCI state codepoint mapped to a TCI state 415-c over resources of a CORESET 405-d. In response to receiving the DCI 410-c, the UE may apply the TCI state 415-c to the SPS occasions 420 that occur after receiving the DCI 410-c. For example, the UE may apply the TCI state 415-c to the SPS occasion 420-c. That is, the SPS occasion 420-c will become a single TCI state SPS occasion 420-c with the TCI state 415-c applied. In another example, in response to receiving the DCI 410-c, the UE may deactivate SPS. That is, the DCI 410-a may serve as a deactivation DCI and the UE may not receive signaling from the first TRP and the second TRP over resources of the SPS occasion 420-c.

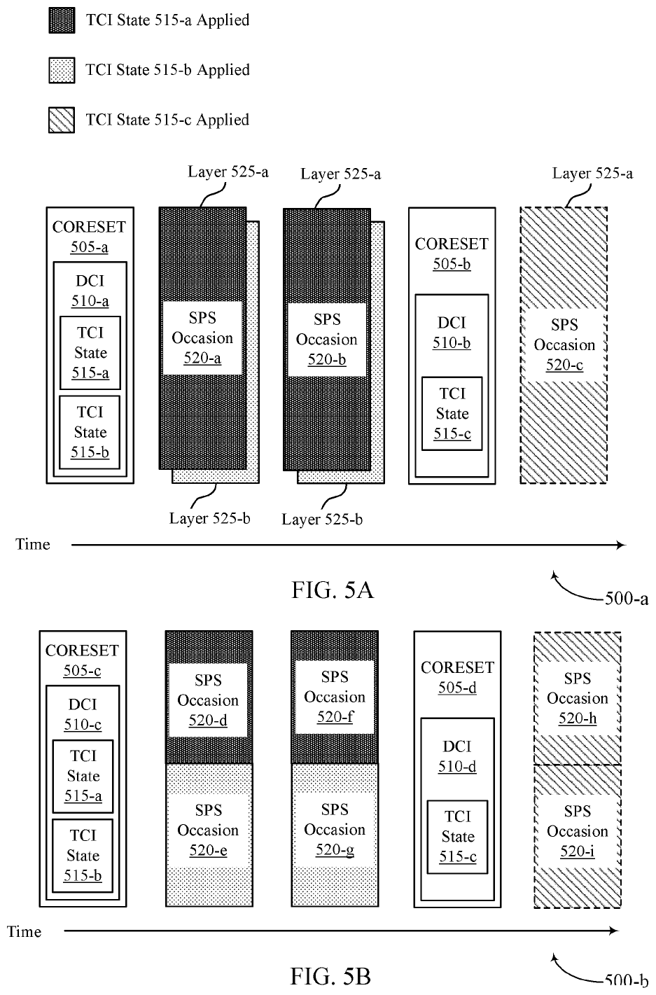

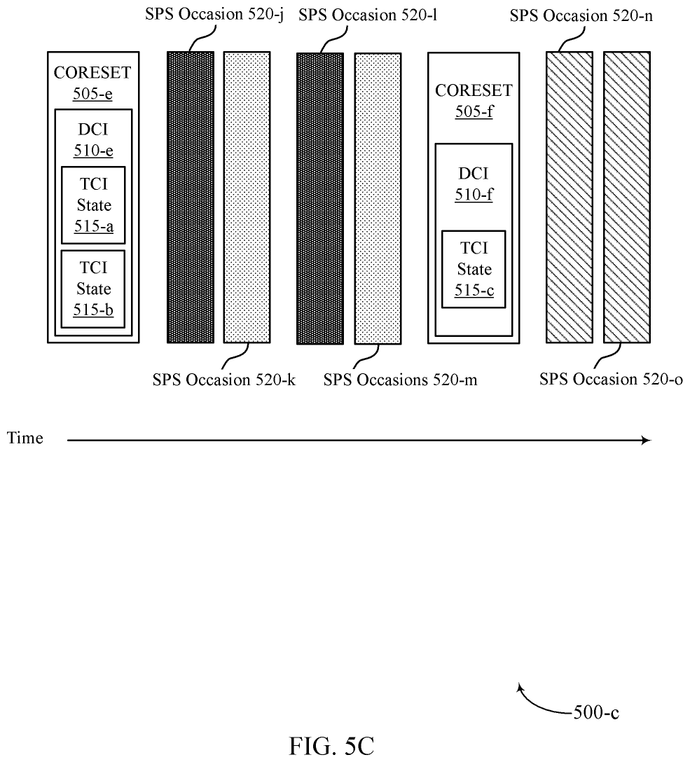

FIGS. 5A, 5B, and 5C illustrate examples of a TCI state update scheme 500 (e.g., a TCI state update scheme 500-a, a TCI state update scheme 500-b, and a TCI state update scheme 500-c) that supports updating TCI states for P/SP communications in accordance with one or more aspects of the present disclosure. In some examples, the TCI state update scheme 500-a, the TCI state update scheme 500-b, and the TCI state update scheme 500-c may be implemented by aspects of a wireless communications system 100 and a wireless communication system 200. For example, the TCI state update scheme 500-a, the TCI state update scheme 500-b, and the TCI state update scheme 500-c may be implemented by a TRP 205 or a UE 115 as described with reference to FIG. 2.

As described in FIG. 2, a UE may communicate with multiple TRPs (e.g., multi-TRP operation). For example, the UE may communicate with a first TRP and a second TRP. In some examples, in order to receive signaling from both the first TRP and the second TRP, the UE may operate in accordance to SDM. Using SDM, the UE may receive signaling from the first TRP and the second TRP using the same frequency and time resources, but utilizing different spatial layer sets 525.

In the example of FIG. 5A, the UE may receive DCI 510-a over resources of a CORESET 505-a. The DCI 510-a may include a TCI codepoint mapped to a TCI state 515-a corresponding to the first TRP and a TCI state 515-b corresponding to the second TRP. Additionally, the DCI 510-a may activate P/SP communications. For example, DCI 510-a may activate a SPS. That is, in response to receiving the DCI 510-c, the UE may receive signaling over resources repeated over a set of SPS occasions 520. As described above, the UE may operate in accordance to SDM. As such, the SPS occasions 520 for the first TRP may overlap time and frequency resources of the SPS occasion 520 for the second TRP. But the signaling received from the first TRP during the SPS occasion 520 may be mapped to a spatial layer set 525-a and the signaling receive from the second TRP during the SPS occasion 520 may be mapped to a spatial layer set 525-b.

The UE may receive signaling from the first TRP using a directional beam based on the TCI state 515-a and the second TRP using a directional beam based on the TCI state 515-b over resources of an SPS occasion 520-a and an SPS occasion 520-b. After the SPS occasion 520-b, the UE may receive DCI 510-b including a TCI state codepoint mapped to a TCI state 515-c. In response to receiving the DCI 510-b, the UE may deactivate a spatial layer set 525 corresponding to one of the first TRP or the second TRP (e.g., a first CDM group or a second CDM group) and apply the TCI state 515-c to the remaining spatial layer set 525. For example, the UE may deactivate the spatial layer set 525-b and apply the TCI state 515-c to the spatial layer set 525-a. As such, during SPS occasion 520-c, the UE may receive signaling from the first TRP via the spatial layer set 525-a and may not receive signaling from the second TRP. In some examples, the UE may select the spatial layer set 525 to deactivate based on a configuration (e.g., RRC configuration) received from the base station or a predetermined rule. The configuration may indicate to keep the spatial layer that corresponds to the TRP with the lowest ID number (e.g., keep the spatial layer set 525 that corresponds to a TRP with a TRP ID of 1).

In another example, upon receiving the DCI 510-b, the UE may keep transmission for both the first TRP and the second TRP (e.g., the first CDM group or the second CDM group) and apply the TCI state 515-c to both the spatial layer set 525-a corresponding to the first TRP and the spatial layer set 525-b corresponding to the second TRP. As such, the UE may receive signaling from the first TRP and the second TRP during SPS occasion 520-c using a directional beam based on the TCI state 515-c. In another example, in response to receiving the DCI 510-b, the UE may deactivate SPS. That is, the DCI 510-b may serve as a deactivation DCI and the UE may not receive signaling from the first TRP and the second TRP over resources of the SPS occasion 520-c.

In the example of FIG. 5B, the UE may operate in accordance to FDM in order to communicate with the first TRP and the second TRP. Using FDM, the UE may receive signaling from the first TRP and the second TRP using the same time resources, but different frequency resources. The UE may receive DCI 510-c over resources of a CORESET 505-c. The DCI 510-c may include a TCI codepoint mapped to a TCI state 515-a corresponding to the first TRP and a TCI state 515-b corresponding to the second TRP. Additionally, the DCI 510-c may activate P/SP communications. For example, DCI 510-c may activate SPS. That is, upon receiving the DCI 510-c, the UE may receive signaling over resources repeated over a set of SPS occasions 520. As described above, the UE may operate in accordance to FDM for TRPs. As such, the SPS occasions 520 for the first TRP may overlap time resources of the SPS occasion 520 for the second TRP, but may not overlap frequency resources.

The UE may receive signaling from the first TRP using a directional beam based on the TCI state 515-a during the SPS occasion 520-d and the SPS occasion 520-f. Additionally, the UE may receive signaling from the second TRP using a directional beam based on the TCI state 515-b during the SPS occasion 520-e and the SPS occasion 520-g. After the SPS occasion 520-f and the SPS occasion 520-g, the UE may receive DCI 510-d including a TCI state codepoint mapped to a TCI state 515-c. In response to receiving the DCI 510-d, the UE may apply the TCI state 515-c to the SPS occasions 520 that occur after receiving the DCI 510-d. For example, the UE may apply the TCI state 515-c to the SPS occasion 520-h and the SPS occasion 520-i. As such, the UE may receive signaling from the first TRP and/or signaling from the second TRP using a directional beam based on the TCI state 515-c. In another example, in response to receiving the DCI 510-d, the UE may deactivate SPS. That is, the DCI 510-d may serve as a deactivation DCI and the UE may not receive signaling from the first TRP and the second TRP over resources of the SPS occasion 520-h and the SPS occasion 520-i.

In the example of FIG. 5C, the UE may operate in accordance to TDM in order to communicate with the first TRP and the second TRP. Using TDM, the UE may receive signaling from the first TRP and the second TRP using the same frequency resources, but different time resources. The UE may receive DCI 510-e over resources of a CORESET 505-e. The DCI 510-e may include a TCI codepoint mapped to a TCI state 515-a corresponding to the first TRP and a TCI state 515-b corresponding to the second TRP. Additionally, the DCI 510-e may activate P/SP communications. For example, the DCI 510-e may activate SPS. That is, in response to receiving the DCI 510-e, the UE may receive signaling over resources repeated over a set of SPS occasions 520. As described above, the UE may operate in accordance to TDM. As such, the SPS occasions 520 for the first TRP may overlap frequency resources of the SPS occasion 520 for the second TRP, but may not overlap time resources.

The UE may receive signaling from the first TRP using a directional beam based on the TCI state 515-a during the SPS occasion 520-j and the SPS occasion 520-1. Additionally, the UE may receive signaling from the second TRP using a directional beam based on the TCI state 515-b during the SPS occasion 520-k and the SPS occasion 520-m. After the SPS occasion 520-1 and the SPS occasion 520-m, the UE may receive DCI 510-f including a TCI state codepoint mapped to a TCI state 515-f. Upon receiving the DCI 510-d, the UE may apply the TCI state 515-f to the SPS occasions 520 that occur after receiving the DCI 510-d. For example, the UE may apply the TCI state 515-f to the SPS occasion 520-n and the SPS occasion 520-o. As such, the UE may receive signaling from the first TRP or from the second TRP during the SPS occasion 520-0 using a direction beam based on the TCI state 515-f. In another example, in response to receiving the DCI 510-f, the UE may deactivate SPS. That is, the DCI 510-f may serve as a deactivation DCI and as such, the UE may not receive signaling from the first TRP and the second TRP over resources of the SPS occasion 520-n and the SPS occasion 520-o.

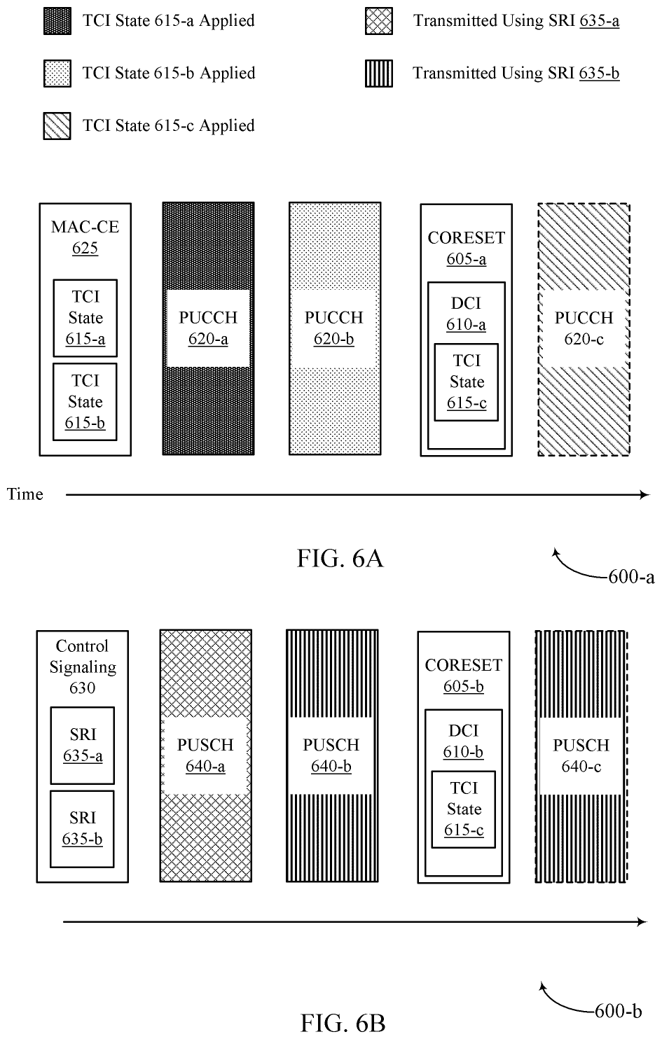

FIGS. 6A and 6B illustrate examples of a TCI update scheme 600 (e.g., a TCI state update scheme 600-a and a TCI state update scheme 600-b) that supports updating TCI states for periodic communications in accordance with one or more aspects of the present disclosure. In some examples, the TCI state update scheme 600-a and the TCI state update scheme 600-b may be implemented by aspects of a wireless communications system 100 and a wireless communication system 200. For example, the TCI state update scheme 600-a and the TCI state update scheme 600-b may be implemented by a TRP 205 or a UE 115 as described with reference to FIG. 2.

As described in FIG. 2, a UE may communicate with multiple TRPs (e.g., multi-TRP operation). For example, the UE may communicate with a first TRP and a second TRP. In some examples, the UE may transmit control signaling to one of the first TRP and the second TRP. The control signaling may be transmitted to the first TRP or the second TRP using a PUCCH resource 620. In some examples, the UE may receive a MAC-CE 625 that include a TCI codepoint mapped to a TCI state 615-a and a TCI state 615-b. Additionally, the MAC-CE 625 may activate repetition of the PUCCH resource 620. As such, the PUCCH resource 620 may be configured to utilize two TCI states 615. In the example of FIG. 2, the repetitions of the PUCCH resources 620 may include a PUCCH resource 620-a, a PUCCH resource 620-b, and a PUCCH resource 620-c. The PUCCH resource 620-a may occur before PUCCH resource 620-b and the PUCCH resource 620-b may occur before the PUCCH resource 620.

In one example, the UE may transmit control signaling to the first TRP using a directional beam based on the TCI state 615-a over the PUCCH resource 620-a. Additionally, the UE may transmit control signaling to the second TRP using a directional beam based on the TCI state 615-b over the PUCCH resource 620-b. After the PUCCH resource 620-b, the UE may receive DCI 610-a including a TCI state codepoint mapped to a TCI state 615-c. In response to receiving the DCI 610-a, the UE may apply the TCI state 615-c to the repetitions of PUCCH resources 620 that occur after receiving the DCI 610-a. For example, the UE may apply the TCI state 615-c to PUCCH resource 620-c. As such, the UE may transmit control signaling to the first TRP or the second TRP over the PUCCH resource 620-c using a direction beam based on the TCI state 615-c. In another example, in response to receiving the DCI 610-a, the UE may deactivate the PUCCH resources 620. That is, the DCI 610-c may serve as a deactivation DCI and as such, the UE may not receive signaling from the first TRP and the second TRP over the PUCCH resource 620-c.

In the example, of FIG. 6B, the UE may be configured with an uplink grant (e.g., a type-1 or a type-2 configured grant). In order to use the configured uplink grant, the UE may receive control signaling 630 (e.g., RRC signaling for type-1 or DCI signaling for type-2) activating the configured uplink grant. Once the configured uplink grant is activated, the UE may transmit signaling to the first TRP and the second TRP using repeated resources (e.g., repeated PUSCH resources) indicated in the configured uplink grant. In some examples, the UE may operate according to TDM (e.g., PUSCH resources 640 corresponding to different TRPs overlap in frequency, but not time) or SDM (e.g., PUSCH resources 640 corresponding to different TRPs overlap in time and frequency). Additionally, the control signaling 630 may include an indicator of an SRI 635-a and an SRI 635-b. The SRI 635-a may correspond to a first resource set allocated for SRSs and the SRI 635-b may correspond to a second resource allocated for SRSs. The first resource set may be mapped to the TCI state 615-a corresponding to the first TRP and the second resource set may be mapped to the TCI state 615-b corresponding to the second TRP.

The UE may transmit signaling to the first TRP using a directional beam based on the TCI state 615-a over at least a portion of PUSCH resource 640-a and the PUSCH resource 640-b. Additionally, the UE may transmit signaling to the second TRP using a directional beam based on the TCI state 615-b over at least a portion of the PUSCH resource 640-a and the PUSCH resource 640-b. After the PUSCH resource 640-b, the UE may receive DCI 610-b over resources of a CORESET 605-b, where the DCI 610-b includes a TCI state codepoint mapped to a TCI state 615-c. In response to receiving the DCI 610-b, the UE may reset one of the TCI states 615 corresponding to one of the SRIs 635 to the TCI state 615-a. For example, the UE may reset the TCI state 615-a to the TCI state 615-c. As such, the UE may transmit signaling to the first TRP using a directional beam based on the TCI state 615-c over at least a portion of PUSCH resource 640-c. Additionally, the UE may transmit signaling to the second TRP using a directional beam based on the TCI state 615-b over at least a portion of the PUSCH resource 640-c. Alternatively, the UE may select one of the two SRIs and reset the corresponding TCI state 615 to the TCI state 615-c. For example, the UE may select the SRI 635-a and reset SRI 635-a to the be SRI 635-c. In such case, the UE may transmit signaling to the first TRP using a directional beam based on the TCI state 615-b and the UE may not transmit signaling to the second TRP. Alternatively, upon receiving the DCI 610-b, the UE may deactivate the configured uplink grant. That is, the UE may not transmit over the PUSCH resource 640-c.

In some aspects, the UE may determine based on a rule or RRC configuration to update only one of the PUSCH occasions in PUSCH resource 640 originally indicated by the two SRIs, by resetting the corresponding TCI state to the indicated TCI state. For example, the UE may determine that the PUSCH occasions in PUSCH resource 640 associated with the first SRI for the first SRS resource set or for the SRS resource set mapped to the first TRP to be updated with the TCI state 615-c, while the PUSCH occasions in PUSCH resource 640 associated with the second SRI for the second SRS resource set or for the SRS resource set mapped to the second TRP are not updated with the TCI state 615-c. In some aspects, the UE may determine based on a rule or RRC configurations to transmit only one of the PUSCH occasions in PUSCH resource 640 originally indicated by the two SRIs. For example, the UE may determine that the PUSCH occasions in PUSCH resource 640 associated with the first SRI for the first SRS resource set or for the SRS resource set mapped to the first TRP to be transmitted with the TCI state 615-c, while the PUSCH occasions in PUSCH resource 640 associated with the second SRI for the second SRS resource set or for the SRS resource set mapped to the second TRP are not transmitted.

In some aspects, for mDCI based mTRP operations, when a TCI state in a TCI codepoint is selected by a DCI associated with a CORESET for a given CORESET pool index, or by a MAC-CE which activates a single TCI for a given CORESET pool index, the UE may use the TCI state selected for the same CORESET pool index as the signal scheduling or activating the P/SP communications to the P/SP channels and/or reference signals.

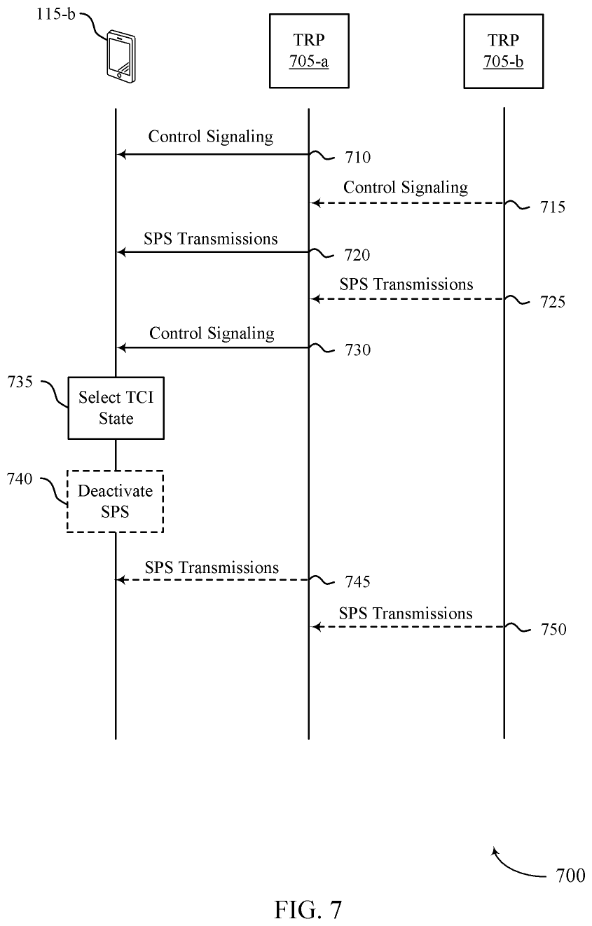

FIG. 7 illustrates an example of a process flow 700 that supports updating TCI states for periodic communications in accordance with one or more aspects of the present disclosure. In some examples, the process flow 700 may be implemented by aspects of a wireless communications system 100 and a wireless communication system 200. For example, the process flow 700 may be implemented by a UE 115-b, a TRP 705-a, and a TRP 705-b which may be examples of a UE 115 and TRPs 205 as described with reference to FIG. 2. Alternative examples of the following may be implemented, where some steps are performed in a different order than described or are not performed at all. In some cases, steps may include additional features not mentioned below, or further steps may be added.

At 705, the UE 115-b may receive control signaling from the TRP 705-a. In some examples, the control signaling may be an example of DCI and may activate SPS at the UE 115-b (e.g., SPS transmissions over a set of SPS occasions). Additionally, in some examples, the DCI may include a TCI codepoint mapped to one or more TCI states. For single TRP operation, the TCI codepoint may be mapped to a first TCI state that corresponds to the TRP 705-a. Alternatively, for multi-TRP operation, the control signaling may be an example of a sDCI and include a TCI codepoint mapped to a first TCI state corresponding to the TRP 705-a and a second TCI state corresponding to the TRP 705-b.

In another example, for multiple TRP operation, the control signaling may be an example of mDCI that includes a TCI codepoint mapped to a first TCI state corresponding to a first CORESET (e.g., configured for the TRP 705-a) over which the control signaling was received. Additionally, in such an example, the UE 115-b may receive control signaling at 715. The control signaling received at 715 may be an example of mDCI that includes a TCI codepoint mapped to a second TCI state corresponding to a second CORESET (e.g., configured for the TRP 705-b) over which the control signaling was received.

At 720, the UE 115-b may receive SPS transmissions over a first subset of the set of SPS occasions 720 using a directional beam that the UE 115-b determined using first TCI state indicated in the control signaling received at 710.

Additionally, at 725 and in the case of multi-TRP operation, the UE 115-b may receive SPS transmission over a second subset of the set of SPS occasions using a directional beam that the UE 115-b determines using the second TCI state indicated in either the control signaling received at 710 or the control signaling received at 715.

At 730, the UE 115-b may receive control signaling from the TRP 705-a. The control signaling may be an example of a DCI and may include a TCI codepoint mapped to a third TCI state.

At 735, the UE 115-b may select a TCI state for future SPS transmissions corresponding to the control signaling received at 710 and potentially at 715. For single TRP operation, the UE 115-b may select the third TCI state and apply the third TCI state to future SPS transmissions (e.g., SPS transmissions over a third subset of SPS occasions) from the TRP 705-a. In another example, for multi-TRP operation, the UE 115-b may select the third TCI state and apply the TCI to future SPS transmission from the TRP 705-a and the TRP 705-b (e.g., SPS transmissions over a third subset of SPS occasions and a fourth subset of SPS occasions, respectively). Alternatively, for multi-TRP operation, the UE 115-b may deactivate SPS upon receiving the control signaling 735. That is, the UE 115-b may not receive SPS transmissions from the TRP 705-a and the TRP 705-b.

In some examples, the TRP 705-a and the TRP 705-b may transmit the SPS transmissions to the UE 115-b using SFN, SDM, TDM, or FDM. In the case of SDM, the UE 115-b may receive the SPS transmissions from the TRP 705-a during the first subset of the SPS occasions using a first spatial layer and a second spatial layer and the UE 115-b may receive the SPS transmission from the TRP 705-b during the second subset of SPS occasion using a second spatial layer. Upon receiving the control signaling at 730, the UE 115-b may deactivate the first spatial layer and apply the third TCI state to future SPS transmission received from the TRP 705-b using the second spatial layer. Altenatively, the UE 115-b may apply the third TCI state to future SPS transmission received from the TRP 705-b using the second spatial layer and future SPS transmission received from the TRP 705-b using the first spatial layer.

At 745, the UE 115-b may potentially receive SPS transmissions from the TRP 705-a using a directional beam determined using the third TCI state. At 750, the UE 115-b may potentially receive SPS transmission from the TRP 705-b using a directional beam determined using the third TCI state.

In some examples, the UE 115-b may be configured with a repeating SFN CORESET, where the CORESET is configured to utilize the first TCI state mapped to the TRP 705-a and the second TCI state mapped to the TRP 705-b. During repetition of the SFN CORESET, the UE 115-b may receive control signaling indicating the third TCI state and upon receiving the control signaling, the UE 115-c may apply the third TCI to the CORESET. That is, the UE 115-b may receive signaling over the SFN CORESET from either the TRP 705-a and the TRP 705-b using a directional beam determined using the third TCI state. Alternatively, upon receiving the control signaling, the UE 115-b may deactivate all search spaces associated with the CORESET.

In some examples, the UE may be configured with an uplink grant. Upon activation of the uplink grant, the UE 115-b may transmit uplink signaling to both the TRP 705-a and TRP 705-b over a set of configured grant occasions. In some examples, the UE 115-b may receive control signaling (e.g., RRC signaling) activating the configured grant and the configured grant may include an indication of a first SRI corresponding to the first TCI state and a second SRI corresponding to the second TCI state. In some examples, while the configured grant is active, the UE 115-b may receive control signaling indicating a third TCI state. Upon receiving the control signaling, the UE 115-b may update the first SRI such that the first SRI corresponds to the third TCI state and optionally, deactivate the second SRI. Alternatively, the UE 115-b may deactivate the configured grant based on receiving the control signaling.

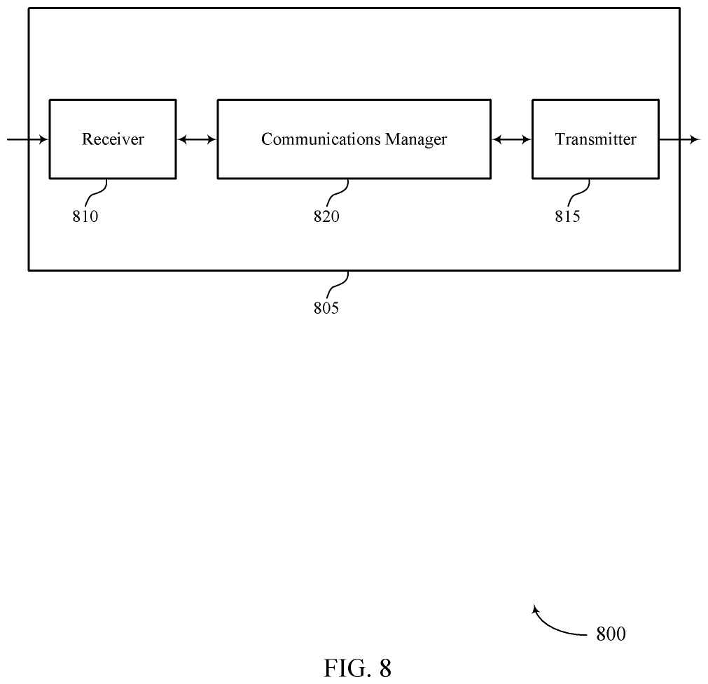

FIG. 8 shows a block diagram 800 of a device 805 that supports updating TCI states for periodic communications in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to updating TCI states for periodic communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to updating TCI states for periodic communications). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of updating TCI states for periodic communications as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. For example, the communications manager 820 may be configured as or otherwise support a means for receiving a first control information message indicating a first TCI codepoint mapped to one or more first unified TCI states, where the first control information message activates a set of periodic occasions for communications between the UE and a first transmission and reception point of a network entity, a second transmission and reception point of the network entity, or both, using the one or more first unified TCI states. The communications manager 820 may be configured as or otherwise support a means for receiving, after receiving the first control information message, a second control information message indicating a second TCI codepoint mapped to a single second unified TCI state. The communications manager 820 may be configured as or otherwise support a means for selecting a unified TCI state from the one or more first unified TCI states or the single second unified TCI state to apply to at least a portion of the communications.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, and more efficient utilization of communication resources.

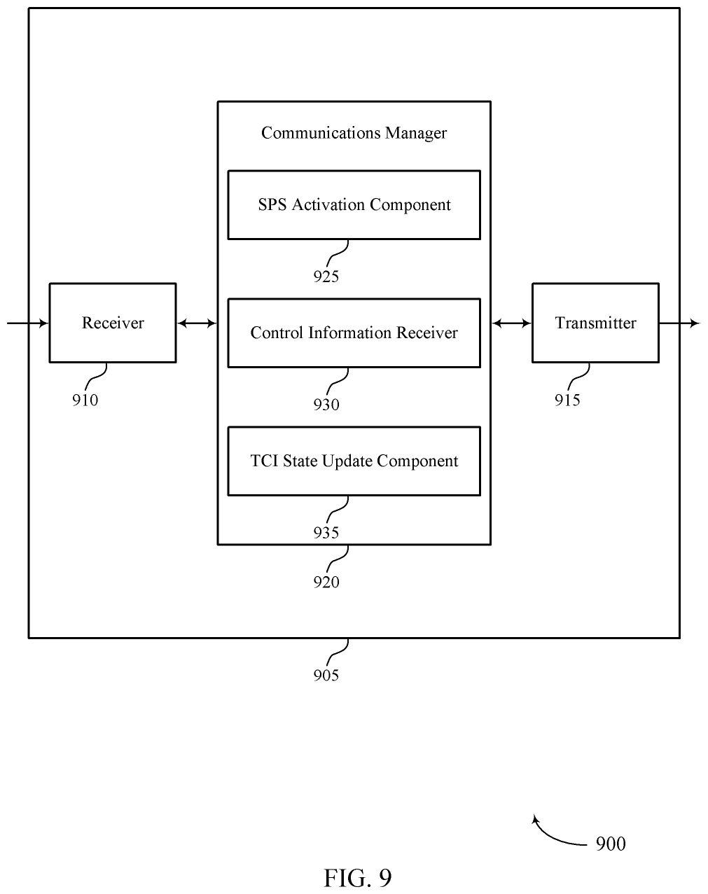

FIG. 9 shows a block diagram 900 of a device 905 that supports updating TCI states for periodic communications in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to updating TCI states for periodic communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to updating TCI states for periodic communications). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of updating TCI states for periodic communications as described herein. For example, the communications manager 920 may include an SPS activation component 925, a control information receiver 930, a TCI state update component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The SPS activation component 925 may be configured as or otherwise support a means for receiving a first control information message indicating a first TCI codepoint mapped to one or more first unified TCI states, where the first control information message activates a set of periodic occasions for communications between the UE and a first transmission and reception point of a network entity, a second transmission and reception point of the network entity, or both, using the one or more first unified TCI states. The control information receiver 930 may be configured as or otherwise support a means for receiving, after receiving the first control information message, a second control information message indicating a second TCI codepoint mapped to a single second unified TCI state. The TCI state update component 935 may be configured as or otherwise support a means for selecting a unified TCI state from the one or more first unified TCI states or the single second unified TCI state to apply to at least a portion of the communications.

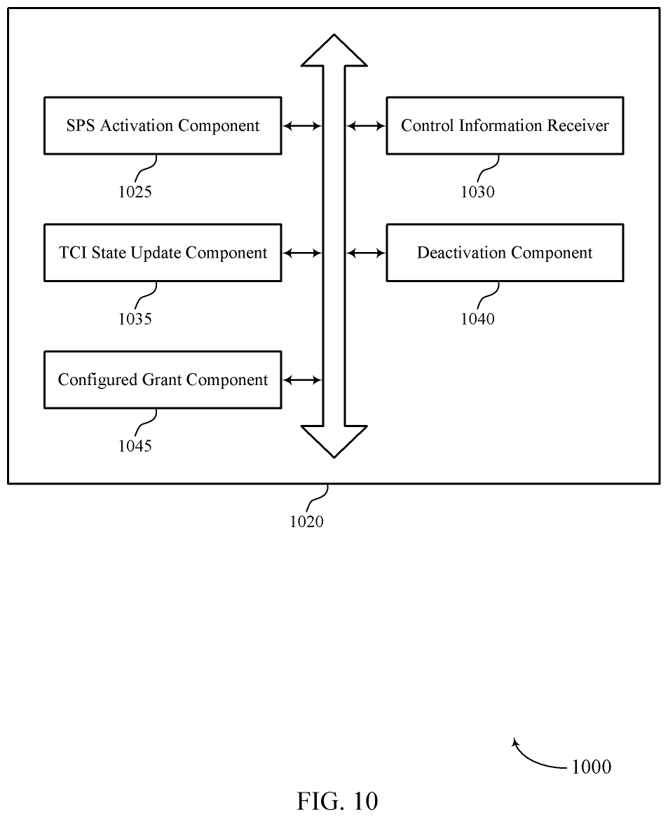

FIG. 10 shows a block diagram 1000 of a communications manager 1020 that supports updating TCI states for periodic communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of updating TCI states for periodic communications as described herein. For example, the communications manager 1020 may include an SP activation component 1025, a control information receiver 1030, a TCI state update component 1035, a deactivation component 1040, a configured grant component 1045, or any combination thereof. Each of these components may communicate, directly or indirectly, with one another (e.g., via one or more buses).

The communications manager 1020 may support wireless communication at a UE in accordance with examples as disclosed herein. The SPS activation component 1025 may be configured as or otherwise support a means for receiving a first control information message indicating a first TCI codepoint mapped to one or more first unified TCI states, where the first control information message activates a set of periodic occasions for communications between the UE and a first transmission and reception point of a network entity, a second transmission and reception point of the network entity, or both, using the one or more first unified TCI states. The control information receiver 1030 may be configured as or otherwise support a means for receiving, after receiving the first control information message, a second control information message indicating a second TCI codepoint mapped to a single second unified TCI state. The TCI state update component 1035 may be configured as or otherwise support a means for selecting a unified TCI state from the one or more first unified TCI states or the single second unified TCI state to apply to at least a portion of the communications.

In some examples, to support selecting the unified TCI state, the TCI state update component 1035 may be configured as or otherwise support a means for selecting the single second unified TCI state to apply to at least a subset of the set of periodic occasions regardless of whether the single first unified TCI state was for either the first transmission and reception point or the second transmission and reception point.

In some examples, to support selecting the unified TCI state, the TCI state update component 1035 may be configured as or otherwise support a means for selecting the single second unified TCI state to apply to at least a subset of the set of periodic occasions.

In some examples, the first TCI codepoint is mapped to at least two first unified TCI states, and the deactivation component 1040 may be configured as or otherwise support a means for deactivating a subset of the set of periodic occasions based on receiving the second control information message.

In some examples, the first TCI codepoint is mapped to at least two first unified TCI states, and the control information receiver 1030 may be configured as or otherwise support a means for receiving, from the first transmission and reception point and the second transmission and reception point, first control signaling over a control resource set using directional beams corresponding to the at least two first unified TCI states.

In some examples, the control information receiver 1030 may be configured as or otherwise support a means for receiving, from one of the first transmission and reception point or the second transmission and reception point, second control signaling over the control resource set using a directional beam corresponding to the single second unified TCI state based on receiving the second control information message.

In some examples, the deactivation component 1040 may be configured as or otherwise support a means for deactivating search spaces associated with the control resource set based on receiving the second control information message.

In some examples, the first TCI codepoint is mapped to at least two first unified TCI states. In some examples, each of the at least two first unified TCI states is associated with a respective subset of the set of periodic occasions, the respective subsets of the set of periodic occasions overlapping in a time domain and a frequency domain.

In some examples, the first TCI codepoint is mapped to at least two first unified TCI states. In some examples, each of the at least two first unified TCI states corresponds to a respective spatial layer.

In some examples, the deactivation component 1040 may be configured as or otherwise support a means for deactivating a first respective spatial layer based on receiving the second control information message, where selecting the unified TCI state includes. In some examples, the TCI state update component 1035 may be configured as or otherwise support a means for selecting the single second unified TCI state to apply to the at least portion of the communications that are transmitted or received over a subset of the set of periodic occasions using a second respective spatial layer.

In some examples, the TCI state update component 1035 may be configured as or otherwise support a means for selecting the single second unified TCI state to apply to the at least portion of the communications that are transmitted or received over a subset of the set of periodic occasions using a first respective spatial layer and a second respective spatial layer.

In some examples, the first TCI codepoint is mapped to at least two unified first TCI states. In some examples, each of the at least two first unified TCI states are associated with a respective subset of the set of periodic occasions. In some examples, the respective subsets of the set of periodic occasion are non-overlapping in either a frequency domain or a time domain.

In some examples, the configured grant component 1045 may be configured as or otherwise support a means for receiving control signaling indicating at least two resource sets associated with a sounding reference signal, each of the at least two resource sets corresponding to a respective first unified TCI state of the one or more first unified TCI states, where the control signaling activates a second set of periodic occasions for uplink signaling between the UE and the first transmission and reception point, the second transmission and reception point, or both, using the one or more first unified TCI states.

In some examples, the TCI state update component 1035 may be configured as or otherwise support a means for updating a resource set of the at least two resource sets such that the resource set corresponds to the single second unified TCI state based on receiving the second control information message.

In some examples, the deactivation component 1040 may be configured as or otherwise support a means for deactivating a first resource set of the at least two resource sets based on receiving the second control information message. In some examples, the TCI state update component 1035 may be configured as or otherwise support a means for updating a second resource set of the at least two resource sets such that the second resource set corresponds to the single second unified TCI state based on receiving the second control information message.

In some examples, the deactivation component 1040 may be configured as or otherwise support a means for deactivating a subset of the second set of periodic occasions based on receiving the second control information message.

In some examples, the first control information message indicating the first TCI codepoint mapped to a single first unified TCI state is received over a first control resource set and activates the set of periodic occasions for communication between the UE and the first transmission and reception point, and the SPS activation component 1025 may be configured as or otherwise support a means for receiving a third control information message indicating third TCI codepoint mapped to a single third unified TCI state over a second control resource set, where the third control information message activates a second set of periodic occasions for communication between the UE and the second transmission and reception point. In some examples, the first control information message indicating the first TCI codepoint mapped to a single first unified TCI state is received over a first control resource set and activates the set of periodic occasions for communication between the UE and the first transmission and reception point, and the TCI state update component 1035 may be configured as or otherwise support a means for selecting the single second unified TCI state to apply to a subset of the set of periodic occasions and a subset of the second set of periodic occasions.

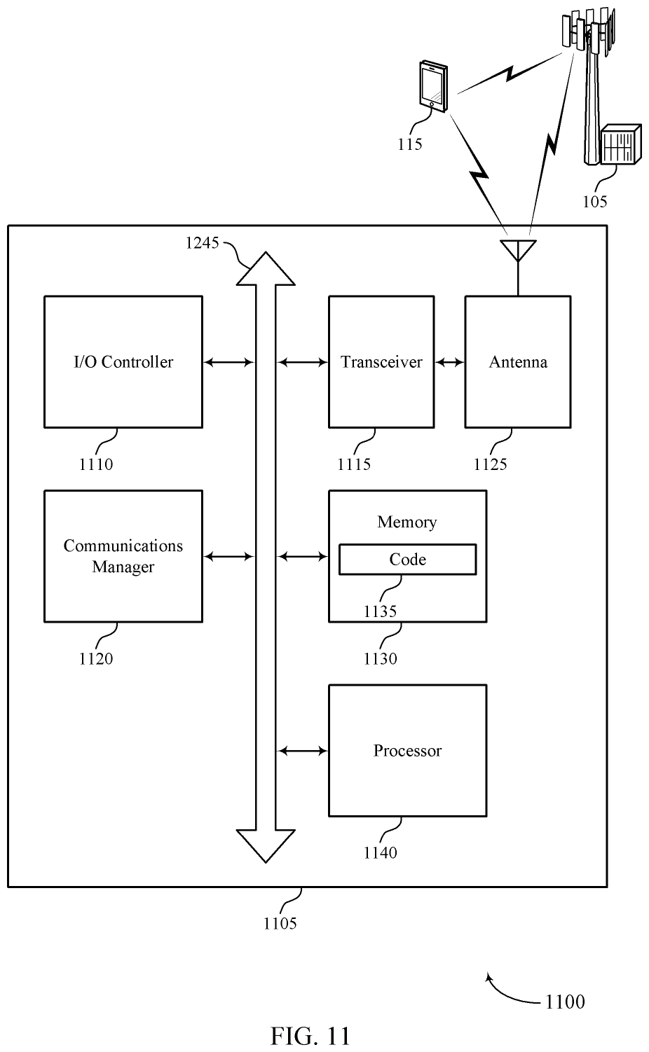

FIG. 11 shows a diagram of a system 1100 including a device 1105 that supports updating TCI states for periodic communications in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting updating TCI states for periodic communications). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for receiving a first control information message indicating a first TCI codepoint mapped to one or more first unified TCI states, where the first control information message activates a set of periodic occasions for communications between the UE and a first transmission and reception point of a network entity, a second transmission and reception point of the network entity, or both, using the one or more first unified TCI states. The communications manager 1120 may be configured as or otherwise support a means for receiving, after receiving the first control information message, a second control information message indicating a second TCI codepoint mapped to a single second unified TCI state. The communications manager 1120 may be configured as or otherwise support a means for selecting a unified TCI state from the one or more first unified TCI states or the single second unified TCI state to apply to at least a portion of the communications.

By including or configuring the communications manager 1120 in accordance with examples as described herein, the device 1105 may support techniques for improved communication reliability, reduced latency, more efficient utilization of communication resources, and improved coordination between devices.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of updating TCI states for periodic communications as described herein, or the processor 1140 and the memory 1130 may be otherwise configured to perform or support such operations.

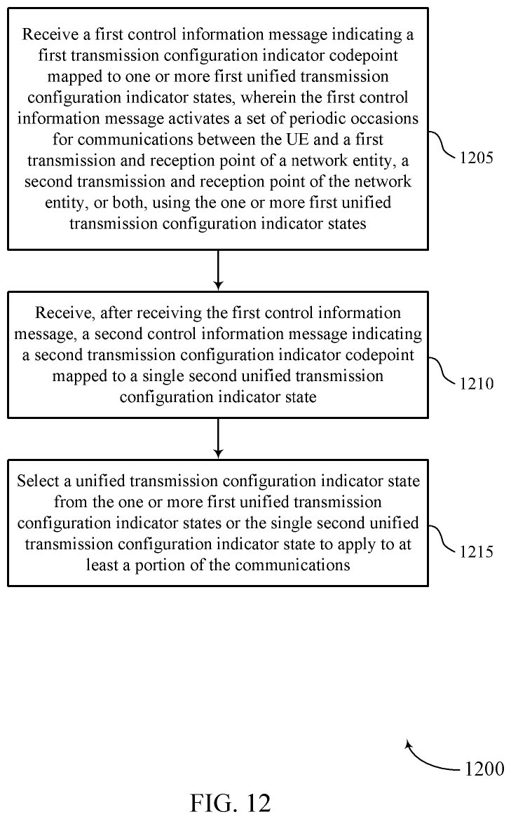

FIG. 12 shows a flowchart illustrating a method 1200 that supports updating TCI states for periodic communications in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving a first control information message indicating a first TCI codepoint mapped to one or more first unified TCI states, where the first control information message activates a set of periodic occasions for communications between the UE and a first transmission and reception point of a network entity, a second transmission and reception point of the network entity, or both, using the one or more first unified TCI states. The operations of 1205 may be performed in accordance with examples as disclosed herein. In some examples, aspects of the operations of 1205 may be performed by an SPS activation component 1025 as described with reference to FIG. 10.

At 1210, the method may include receiving, after receiving the first control information message, a second control information message indicating a second TCI codepoint mapped to a single second unified TCI state. The operations of 1210 may be performed in accordance with examples as disclosed herein. In some examples, aspects of the operations of 1210 may be performed by a control information receiver 1030 as described with reference to FIG. 10.

At 1215, the method may include selecting a unified TCI state from the one or more first unified TCI states or the single second unified TCI state to apply to at least a portion of the communications. The operations of 1215 may be performed in accordance with examples as disclosed herein. In some examples, aspects of the operations of 1215 may be performed by a TCI state update component 1035 as described with reference to FIG. 10.

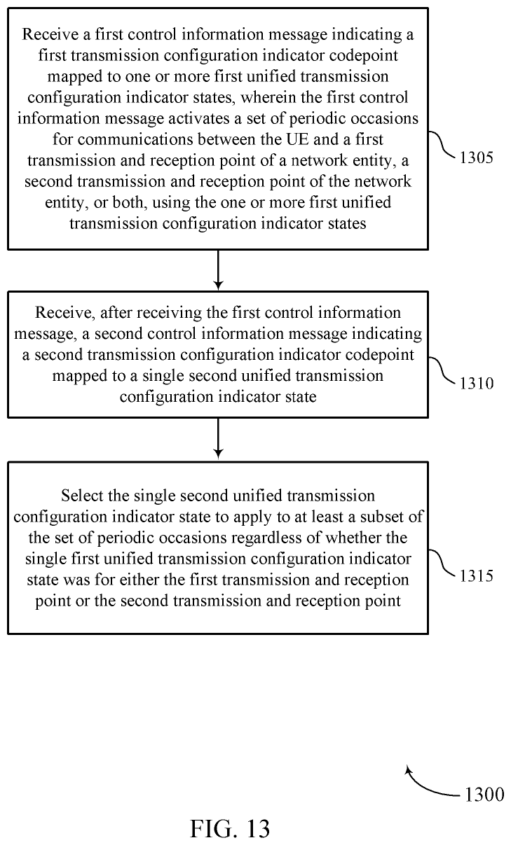

FIG. 13 shows a flowchart illustrating a method 1300 that supports updating TCI states for periodic communications in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving a first control information message indicating a first TCI codepoint mapped to one or more first unified TCI states, where the first control information message activates a set of periodic occasions for communications between the UE and a first transmission and reception point of a network entity, a second transmission and reception point of the network entity, or both, using the one or more first unified TCI states. The operations of 1305 may be performed in accordance with examples as disclosed herein. In some examples, aspects of the operations of 1305 may be performed by an SPS activation component 1025 as described with reference to FIG. 10.

At 1310, the method may include receiving, after receiving the first control information message, a second control information message indicating a second TCI codepoint mapped to a single second unified TCI state. The operations of 1310 may be performed in accordance with examples as disclosed herein. In some examples, aspects of the operations of 1310 may be performed by a control information receiver 1030 as described with reference to FIG. 10.

At 1315, the method may include selecting the single second unified TCI state to apply to at least a subset of the set of periodic occasions regardless of whether the single first unified TCI state was for either the first transmission and reception point or the second transmission and reception point. The operations of 1315 may be performed in accordance with examples as disclosed herein. In some examples, aspects of the operations of 1315 may be performed by a TCI state update component 1035 as described with reference to FIG. 10.

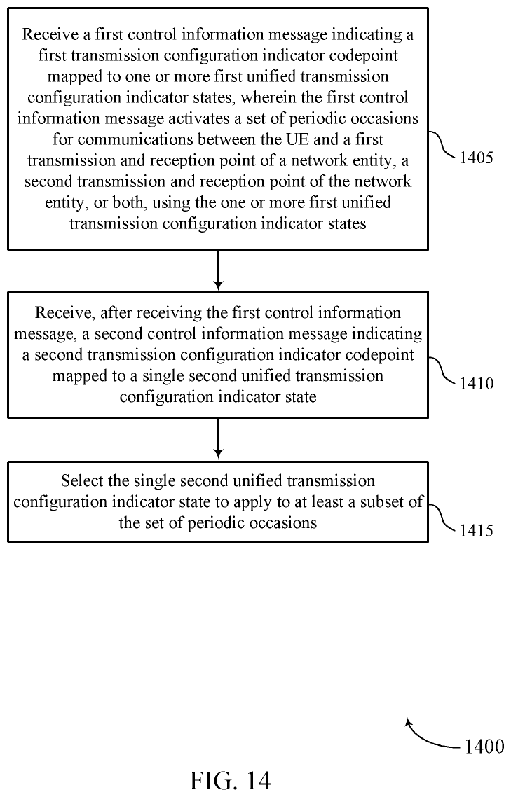

FIG. 14 shows a flowchart illustrating a method 1400 that supports updating TCI states for periodic communications in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving a first control information message indicating a first TCI codepoint mapped to one or more first unified TCI states, where the first control information message activates a set of periodic occasions for communications between the UE and a first transmission and reception point of a network entity, a second transmission and reception point of the network entity, or both, using the one or more first unified TCI states. The operations of 1405 may be performed in accordance with examples as disclosed herein. In some examples, aspects of the operations of 1405 may be performed by an SPS activation component 1025 as described with reference to FIG. 10.

At 1410, the method may include receiving, after receiving the first control information message, a second control information message indicating a second TCI codepoint mapped to a single second unified TCI state. The operations of 1410 may be performed in accordance with examples as disclosed herein. In some examples, aspects of the operations of 1410 may be performed by a control information receiver 1030 as described with reference to FIG. 10.

At 1415, the method may include selecting the single second unified TCI state to apply to at least a subset of the set of periodic occasions. The operations of 1415 may be performed in accordance with examples as disclosed herein. In some examples, aspects of the operations of 1415 may be performed by a TCI state update component 1035 as described with reference to FIG. 10.

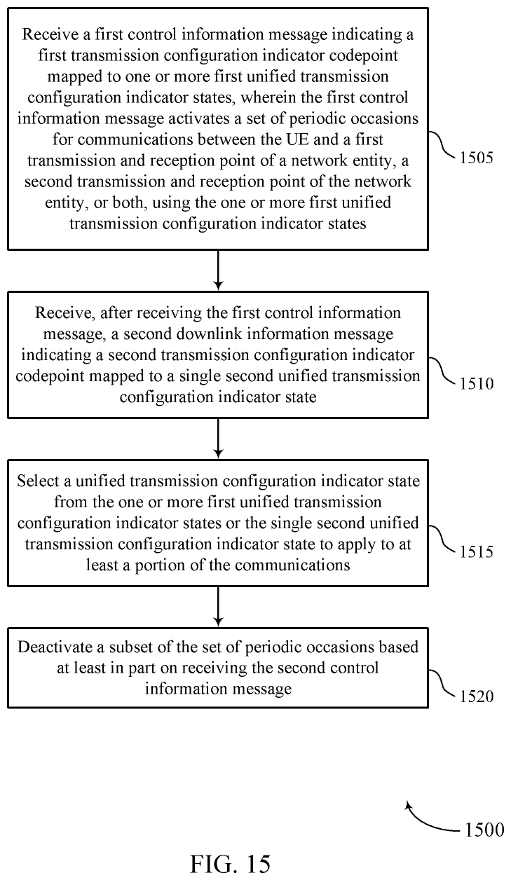

FIG. 15 shows a flowchart illustrating a method 1500 that supports updating TCI states for periodic communications in accordance with one or more aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include receiving a first control information message indicating a first TCI codepoint mapped to one or more first unified TCI states, where the first control information message activates a set of periodic occasions for communications between the UE and a first transmission and reception point of a network entity, a second transmission and reception point of the network entity, or both, using the one or more first unified TCI states. The operations of 1505 may be performed in accordance with examples as disclosed herein. In some examples, aspects of the operations of 1505 may be performed by an SPS activation component 1025 as described with reference to FIG. 10.

At 1510, the method may include receiving, after receiving the first control information message, a second control information message indicating a second TCI codepoint mapped to a single second unified TCI state. The operations of 1510 may be performed in accordance with examples as disclosed herein. In some examples, aspects of the operations of 1510 may be performed by a control information receiver 1030 as described with reference to FIG. 10.

1515, the method may include selecting a unified TCI state from the one or more first unified TCI states or the single second unified TCI state to apply to at least a portion of the communications. The operations of 1515 may be performed in accordance with examples as disclosed herein. In some examples, aspects of the operations of 1515 may be performed by a TCI state update component 1035 as described with reference to FIG. 10.

At 1520, the method may include deactivating a subset of the set of periodic occasions based on receiving the second control information message. The operations of 1520 may be performed in accordance with examples as disclosed herein. In some examples, aspects of the operations of 1520 may be performed by a deactivation component 1040 as described with reference to FIG. 10.

### (A Summary Supporting Multiple-Dependent Claims Will be Added Upon Final Approval of the Claims)

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a first control information message indicating a first transmission configuration indicator codepoint mapped to one or more first unified transmission configuration indicator states, wherein the first control information message activates a set of periodic occasions for communications between the UE and a first transmission and reception point of a network entity, a second transmission and reception point of the network entity, or both, using the one or more first unified transmission configuration indicator states;
receiving, after receiving the first control information message, a second control information message indicating a second transmission configuration indicator codepoint mapped to a single second unified transmission configuration indicator state; and
selecting a unified transmission configuration indicator state from the one or more first unified transmission configuration indicator states or the single second unified transmission configuration indicator state to apply to at least a portion of the communications.

2. The method of claim 1, wherein the first transmission configuration indicator codepoint is mapped to a single first unified transmission configuration indicator state for one of the first transmission and reception point or the second transmission and reception point, and wherein selecting the unified transmission configuration indicator state comprises:
selecting the single second unified transmission configuration indicator state to apply to at least a subset of the set of periodic occasions regardless of whether the single second unified transmission configuration indicator state was for either the first transmission and reception point or the second transmission and reception point.

3. The method of claim 1, wherein the first transmission configuration indicator codepoint is mapped to at least two first unified transmission configuration indicator states, and wherein selecting the unified transmission configuration indicator state comprises:
selecting the single second unified transmission configuration indicator state to apply to at least a subset of the set of periodic occasions.

4. The method of claim 1, wherein the first transmission configuration indicator codepoint is mapped to at least two first unified transmission configuration indicator states, the method further comprising:
deactivating a subset of the set of periodic occasions based at least in part on receiving the second control information message.

5. The method of claim 1, wherein the first transmission configuration indicator codepoint is mapped to at least two first unified transmission configuration indicator states, the method further comprising:
receiving, from the first transmission and reception point and the second transmission and reception point, first control signaling over a control resource set using directional beams corresponding to the at least two first unified transmission configuration indicator states.

6. The method of claim 5, further comprising:
receiving, from one of the first transmission and reception point or the second transmission and reception point, second control signaling over the control resource set using a directional beam corresponding to the single second unified transmission configuration indicator state based at least in part on receiving the second control information message.

7. The method of claim 5, further comprising:
deactivating search spaces associated with the control resource set based at least in part on receiving the second control information message.

8. The method of claim 1, wherein:
the first transmission configuration indicator codepoint is mapped to at least two first unified transmission configuration indicator states; and
each of the at least two first unified transmission configuration indicator states is associated with a respective subset of the set of periodic occasions, the respective subsets of the set of periodic occasions overlapping in a time domain and a frequency domain.

9. The method of claim 1, wherein:
the first transmission configuration indicator codepoint is mapped to at least two first unified transmission configuration indicator states; and
each of the at least two first unified transmission configuration indicator states corresponds to a respective spatial layer.

10. The method of claim 9, further comprising:
deactivating a first respective spatial layer based at least in part on receiving the second control information message, wherein selecting the unified transmission configuration indicator state comprises:
selecting the single second unified transmission configuration indicator state to apply to the at least portion of the communications that are transmitted or received over a subset of the set of periodic occasions using a second respective spatial layer.

11. The method of claim 9, further comprising:
selecting the single second unified transmission configuration indicator state to apply to the at least portion of the communications that are transmitted or received over a subset of the set of periodic occasions using a first respective spatial layer and a second respective spatial layer.

12. The method of claim 1, wherein:
the first transmission configuration indicator codepoint is mapped to at least two unified first transmission configuration indicator states;
each of the at least two first unified transmission configuration indicator states are associated with a respective subset of the set of periodic occasions; and
the respective subsets of the set of periodic occasion are non-overlapping in either a frequency domain or a time domain.

13. The method of claim 1, further comprising:
receiving control signaling indicating at least two resource sets associated with a sounding reference signal, each of the at least two resource sets corresponding to a respective first unified transmission configuration indicator state of the one or more first unified transmission configuration indicator states, wherein the control signaling activates a second set of periodic occasions for uplink signaling between the UE and the first transmission and reception point, the second transmission and reception point, or both, using the one or more first unified transmission configuration indicator states.

14. The method of claim 13, further comprising:
updating a resource set of the at least two resource sets such that the resource set corresponds to the single second unified transmission configuration indicator state based at least in part on receiving the second control information message.

15. The method of claim 13, further comprising:
deactivating a first resource set of the at least two resource sets based at least in part on receiving the second control information message; and
updating a second resource set of the at least two resource sets such that the second resource set corresponds to the single second unified transmission configuration indicator state based at least in part on receiving the second control information message.

16. The method of claim 13, further comprising:
deactivating a subset of the second set of periodic occasions based at least in part on receiving the second control information message.

17. The method of claim 1, wherein the first control information message indicating the first transmission configuration indicator codepoint mapped to a single first unified transmission configuration indicator state is received over a first control resource set and activates the set of periodic occasions for communication between the UE and the first transmission and reception point, the method further comprising:
receiving a third control information message indicating third transmission configuration indicator codepoint mapped to a single third unified transmission configuration indicator state over a second control resource set, wherein the third control information message activates a second set of periodic occasions for communication between the UE and the second transmission and reception point; and
selecting the single second unified transmission configuration indicator state to apply to a subset of the set of periodic occasions and a subset of the second set of periodic occasions.

18. An apparatus for wireless communication at a user equipment (UE), comprising:
a processor;
memory coupled with the processor; and
instructions stored in the memory and executable by the processor to cause the apparatus to:
receive a first control information message indicating a first transmission configuration indicator codepoint mapped to one or more first unified transmission configuration indicator states, wherein the first control information message activates a set of periodic occasions for communications between the UE and a first transmission and reception point of a network entity, a second transmission and reception point of the network entity, or both, using the one or more first unified transmission configuration indicator states;
receive, after receiving the first control information message, a second control information message indicating a second transmission configuration indicator codepoint mapped to a single second unified transmission configuration indicator state; and
select a unified transmission configuration indicator state from the one or more first unified transmission configuration indicator states or the single second unified transmission configuration indicator state to apply to at least a portion of the communications.

19. The apparatus of claim 18, wherein the instructions to select the unified transmission configuration indicator state are executable by the processor to cause the apparatus to:
select the single second unified transmission configuration indicator state to apply to at least a subset of the set of periodic occasions regardless of whether the single second unified transmission configuration indicator state was for either the first transmission and reception point or the second transmission and reception point.

20. The apparatus of claim 18, wherein the instructions to select the unified transmission configuration indicator state are executable by the processor to cause the apparatus to:
select the single second unified transmission configuration indicator state to apply to at least a subset of the set of periodic occasions.

21. The apparatus of claim 18, wherein the first transmission configuration indicator codepoint is mapped to at least two first unified transmission configuration indicator states, and the instructions are further executable by the processor to cause the apparatus to:
deactivate a subset of the set of periodic occasions based at least in part on receiving the second control information message.

22. The apparatus of claim 18, wherein the first transmission configuration indicator codepoint is mapped to at least two first unified transmission configuration indicator states, and the instructions are further executable by the processor to cause the apparatus to:
receive, from the first transmission and reception point and the second transmission and reception point, first control signaling over a control resource set using directional beams corresponding to the at least two first unified transmission configuration indicator states.

23. The apparatus of claim 22, wherein the instructions are further executable by the processor to cause the apparatus to:
receive, from one of the first transmission and reception point or the second transmission and reception point, second control signaling over the control resource set using a directional beam corresponding to the single second unified transmission configuration indicator state based at least in part on receiving the second control information message.

24. The apparatus of claim 22, wherein the instructions are further executable by the processor to cause the apparatus to:
deactivate search spaces associated with the control resource set based at least in part on receiving the second control information message.

25. The apparatus of claim 18, wherein:
the first transmission configuration indicator codepoint is mapped to at least two first unified transmission configuration indicator states, and
each of the at least two first unified transmission configuration indicator states corresponds to a respective spatial layer.

26. The apparatus of claim 25, wherein the instructions are further executable by the processor to cause the apparatus to:
deactivate a first respective spatial layer based at least in part on receiving the second control information message, wherein selecting the unified transmission configuration indicator state comprises:
select the single second unified transmission configuration indicator state to apply to the at least portion of the communications that are transmitted or received over a subset of the set of periodic occasions using a second respective spatial layer.

27. The apparatus of claim 25, wherein the instructions are further executable by the processor to cause the apparatus to:
select the single second unified transmission configuration indicator state to apply to the at least portion of the communications that are transmitted or received over a subset of the set of periodic occasions using a first respective spatial layer and a second respective spatial layer.

28. The apparatus of claim 18, wherein the first control information message indicating the first transmission configuration indicator codepoint mapped to a single first unified transmission configuration indicator state is received over a first control resource set and activates the set of periodic occasions for communication between the UE and the first transmission and reception point, and the instructions are further executable by the processor to cause the apparatus to:
receive a third control information message indicating third transmission configuration indicator codepoint mapped to a single third unified transmission configuration indicator state over a second control resource set, wherein the third control information message activates a second set of periodic occasions for communication between the UE and the second transmission and reception point; and
select the single second unified transmission configuration indicator state to apply to a subset of the set of periodic occasions and a subset of the second set of periodic occasions.

29. An apparatus for wireless communication at a user equipment (UE), comprising:
means for receiving a first control information message indicating a first transmission configuration indicator codepoint mapped to one or more first unified transmission configuration indicator states, wherein the first control information message activates a set of periodic occasions for communications between the UE and a first transmission and reception point of a network entity, a second transmission and reception point of the network entity, or both, using the one or more first unified transmission configuration indicator states;
means for receiving, after receiving the first control information message, a second control information message indicating a second transmission configuration indicator codepoint mapped to a single second unified transmission configuration indicator state; and
means for selecting a unified transmission configuration indicator state from the one or more first unified transmission configuration indicator states or the single second unified transmission configuration indicator state to apply to at least a portion of the communications.

30. A non-transitory computer-readable medium storing code for wireless communication at a user equipment (UE), the code comprising instructions executable by a processor to:
receive a first control information message indicating a first transmission configuration indicator codepoint mapped to one or more first unified transmission configuration indicator states, wherein the first control information message activates a set of periodic occasions for communications between the UE and a first transmission and reception point of a network entity, a second transmission and reception point of the network entity, or both, using the one or more first unified transmission configuration indicator states;
receive, after receiving the first control information message, a second control information message indicating a second transmission configuration indicator codepoint mapped to a single second unified transmission configuration indicator state; and
select a unified transmission configuration indicator state from the one or more first unified transmission configuration indicator states or the single second unified transmission configuration indicator state to apply to at least a portion of the communications.
